(19) United States
(12) Patent Application Publication
(10) Pub. No.: US 2025/0337520 A1
(43) Pub. Date: Oct. 30, 2025

(54) INFORMATION PROCESSING DEVICE, INFORMATION PROCESSING METHOD, COMMUNICATION SYSTEM, AND PROGRAM

(71) Applicant: NIPPON TELEGRAPH AND TELEPHONE CORPORATION, Tokyo (JP)

(72) Inventors: Hironao ABE, Tokyo (JP); Shinichi YOSHIHARA, Tokyo (JP); Hideo KAWATA, Tokyo (JP); Natsuki YASUHARA, Tokyo (JP); Takahiro KUBO, Tokyo (JP); Yuhei KAWAKAMI, Tokyo (JP)

(73) Assignee: NIPPON TELEGRAPH AND TELEPHONE CORPORATION, Tokyo (JP)

(21) Appl. No.: 18/866,627

(22) PCT Filed: May 20, 2022
(86) PCT No.: PCT/JP2022/021024

§ 371 Date: Nov. 18, 2024

(51) Int. Cl. H04L 1/00; H04L 47/431

(52) U.S. Cl. CPC H04L 1/0008; H04L 47/431

(57) ABSTRACT

An information processing device (3) according to the present disclosure includes: an input unit (31) that receives input of a plurality of data units in order; a data unit length comparison unit (36) that compares a length of a first data unit string composed of one or more consecutively received data units among the plurality of data units with a length of a second data unit string composed of one or more data units consecutively received immediately after the data units constituting the first data unit string; and a padding processing unit (37) that performs padding processing on one of the first data unit string and the second data unit string such that the lengths of the first data unit string and the second data unit string become equal to each other.

### TECHNICAL FIELD

The present disclosure relates to an information processing device, an information processing method, a communication system, and a program.

### BACKGROUND ART

Conventionally, it is known that a communication device 91 transmits/receives duplicate frames to/from another communication device 94 via a plurality of paths (paths 92 and 93) in a relay network NW (refer to FIG. 10). For example, in the uninterruptible network system described in PTL 1, duplicate frames are transmitted and received through a plurality of paths. Accordingly, even if a frame is discarded due to switching of a communication path in a relay network, occurrence of a bit error, or the like, and loss of a frame can be curbed.

### CITATION LIST

### Patent Literature

[PTL 1] Japanese Patent Application Publication No. 2005-102157

### SUMMARY OF INVENTION

### Technical Problem

However, in the technique described in PTL 1, it is possible to realize communication with a quality desired by a user by transmitting the same information through a plurality of paths, but twice the bandwidth is used in the relay network, increasing the load of the relay network.

In order to curb such an increase in the load of the relay network, a frame encoding technique for generating an encoded frame by using an exclusive OR of two consecutively input frame strings has been studied. Note that a frame string is data configured by arranging one or more frames in order.

FIG. 11A shows an example of a frame string A and a frame string B which are two consecutively input frame strings. Each of the frame string A and the frame string B is composed of a header, a payload, and a frame check sequence (FCS). As shown in FIG. 11B, the frame string A has information of “110110” and the frame string B has information of “100101”. In such a configuration, as shown in FIG. 11C, the communication device generates information of “010011” indicating an exclusive OR of the frame string A and the frame string B, and as shown in FIG. 11D, generates an encoded frame by adding a header and a frame check sequence to the information.

In this manner, in order to generate a frame by using an exclusive OR, it is required that the two frame strings have the same length. On the other hand, in a case in which the two frame strings have variable lengths, the frame strings A and B may have different lengths, as shown in FIG. 12A. In this case, as shown in FIG. 12B, padding processing for padding (hatched portion in FIG. 12B) is performed on the frame strings such that the length of each frame string is set to a fixed length. Specifically, as shown in FIG. 12C, “00” as shown in the rectangle of the broken line is added to information “1101” of the frame string A and “000” as shown in the rectangle of the dashed line is added to information “100” of the frame string B. In this manner, information of “010100” (FIG. 12D) indicating the exclusive OR of the frame string A and the frame string B to which “00” and “000” have been added is generated, and an encoded frame (FIG. 12E) is generated by adding a header and a frame check sequence to the information. In this manner, the lengths of the frame strings are increased by performing padding processing on each of the two frame strings, and thus frame string transfer efficiency is reduced.

An object of the present disclosure made in view of such circumstances is to provide an information processing device, an information processing method, a communication system, and a program capable of curbing reduction in the frame string transfer efficiency while curbing loss of a frame string (data unit string).

### Solution to Problem

In order to achieve the aforementioned object, an information processing device according to the present disclosure includes: an input unit configured to receive input of a plurality of data units in order; a data unit length comparison unit configured to compare a length of a first data unit string composed of one or more consecutively received data units among the plurality of data units with a length of a second data unit string composed of one or more data units consecutively received immediately after the data units constituting the first data unit string; and a padding processing unit configured to perform padding processing on one of the first data unit string and the second data unit string such that the lengths of the first data unit string and the second data unit string become equal to each other.

Further, to achieve the aforementioned object, an information processing method according to the present disclosure includes: a step of receiving input of a plurality of data units in order; a step of comparing a length of a first data unit string composed of one or more consecutively received data units among the plurality of data units with a length of a second data unit string composed of one or more data units consecutively received immediately after the data units constituting the first data unit string; and a step of performing padding processing on one of the first data unit string and the second data unit string such that the lengths of the first data unit string and the second data unit string become equal to each other.

Further, in order to achieve the aforementioned object, a communication system according to the present disclosure is a communication system including an information processing device and a communication device, in which the information processing device includes: an input unit configured to receive input of a plurality of data units in order; a data unit length comparison unit configured to compare a length of a first data unit string composed of one or more consecutively received data units among the plurality of data units with a length of a second data unit string composed of one or more data units consecutively received immediately after the data units constituting the first data unit string; and a padding processing unit configured to perform padding processing on one of the first data unit string and the second data unit string such that the lengths of the first data unit string and the second data unit string become equal to each other, and the communication device generates an encoded data unit on the basis of the first data unit string and the second data unit string having the same length according to the padding processing performed by the information processing device.

In order to achieve the aforementioned object, a program according to the present disclosure causes a computer to serve as the above-described information processing device.

### Advantageous Effects of Invention

According to the information processing device, the information processing method, the communication system, and the program according to the present disclosure, it is possible to curb reduction in data unit string transfer efficiency while curbing loss of a data unit string.

### BRIEF DESCRIPTION OF DRAWINGS

FIG. 1 is a schematic diagram showing an example of a communication system according to an embodiment of the present disclosure.

FIG. 2 is a schematic diagram showing an example of a frame length shaping device shown in FIG. 1.

FIG. 3A is a diagram showing an example of a plurality of frames input to the frame length shaping device shown in FIG. 1.

FIG. 3B is a diagram for describing storage of a frame string composed of some of the plurality of frames shown in FIG. 3A in a first buffer part or a second buffer part.

FIG. 3C is a diagram for describing one frame string padding of a plurality of frame strings shown in FIG. 3B.

FIG. 4 is a schematic diagram showing an example of a transmitter shown in FIG. 1.

FIG. 5 is a diagram for describing a frame processed by the transmitter shown in FIG. 4.

FIG. 6 is a schematic diagram showing an example of a receiver shown in FIG. 1.

FIG. 7 is a diagram for describing a frame processed by the receiver shown in FIG. 6.

FIG. 8 is a flowchart showing an operation of the frame length shaping device shown in FIG. 2.

FIG. 9 is a diagram showing an example of a hardware configuration of the frame length shaping device shown in FIG. 2.

FIG. 10 is a diagram showing a path of a frame transmitted by a communication device in the prior art.

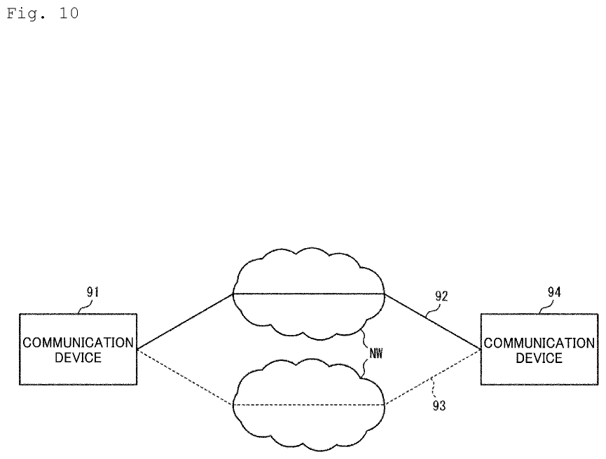

FIG. 11A is a diagram showing a configuration of two consecutive fixed-length frames in the prior art.

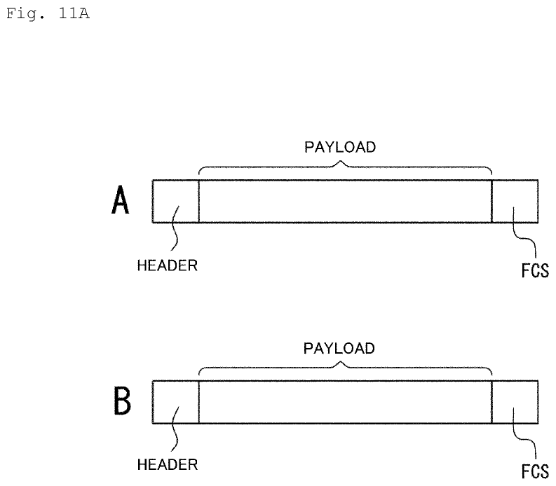

FIG. 11B is a diagram showing information included in the frames shown in FIG. 11A.

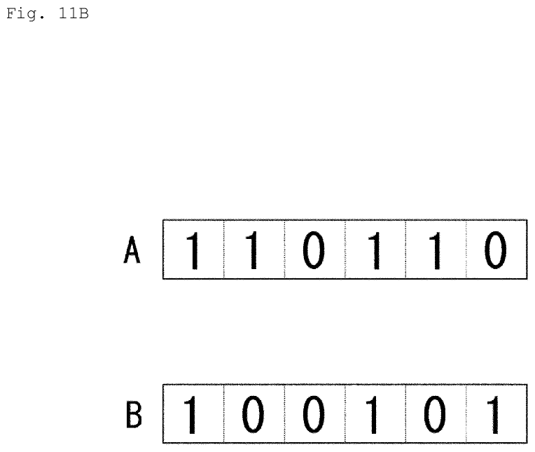

FIG. 11C is a diagram showing an encoded frame generated on the basis of the information included in the frames.

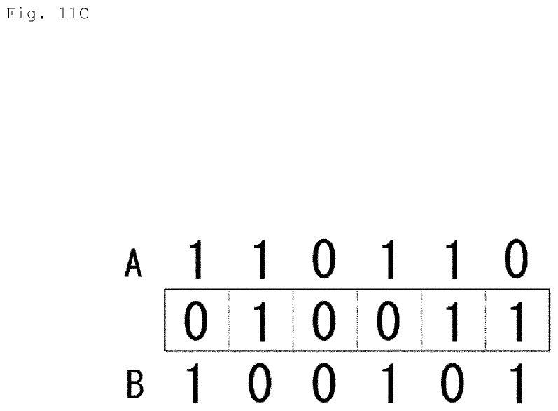

FIG. 11D is a diagram showing a frame obtained by adding a header and a frame check sequence to the encoded frame shown in FIG. 11C.

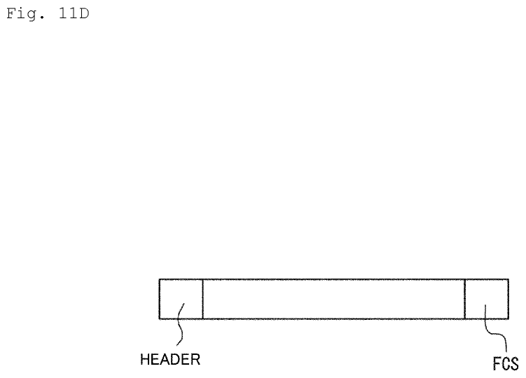

FIG. 12A is a diagram showing a configuration of two consecutive variable-length frames in the prior art.

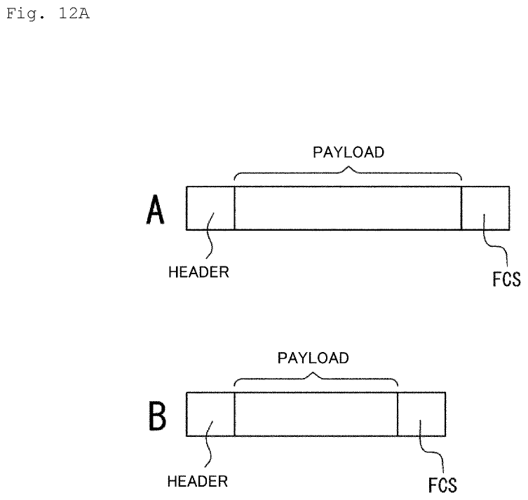

FIG. 12B is a diagram showing frames obtained by performing padding processing on each of the two frames shown in FIG. 12A.

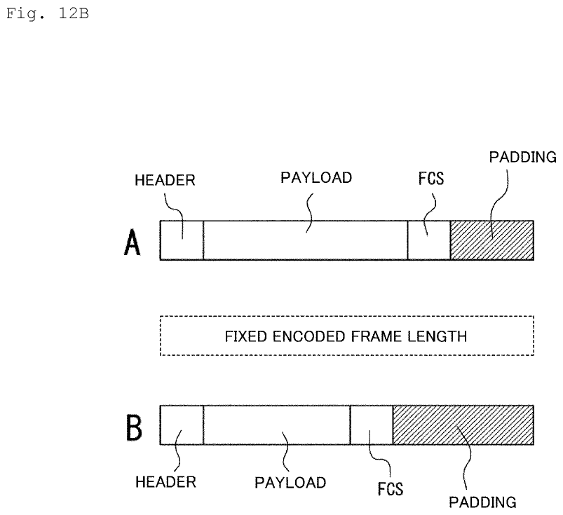

FIG. 12C is a diagram showing information included in each of the frames shown in FIG. 12B.

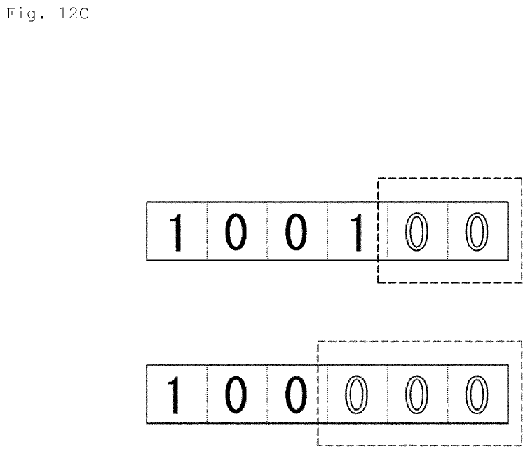

FIG. 12D is a diagram showing an encoded frame generated on the basis of the information included in the frames shown in FIG. 12C.

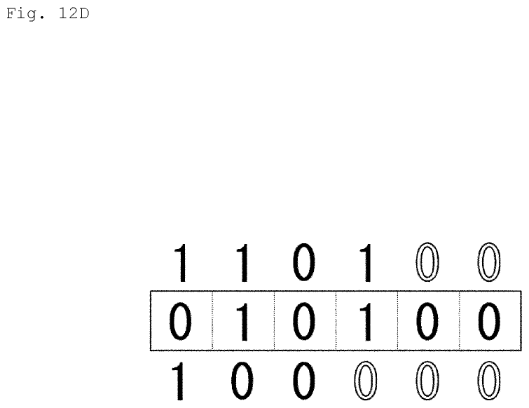

FIG. 12E is a diagram showing a frame obtained by adding a header and a frame check sequence to the encoded frame shown in FIG. 12D.

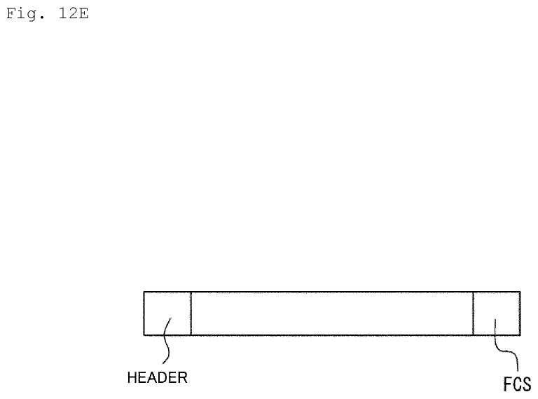

### DESCRIPTION OF EMBODIMENTS

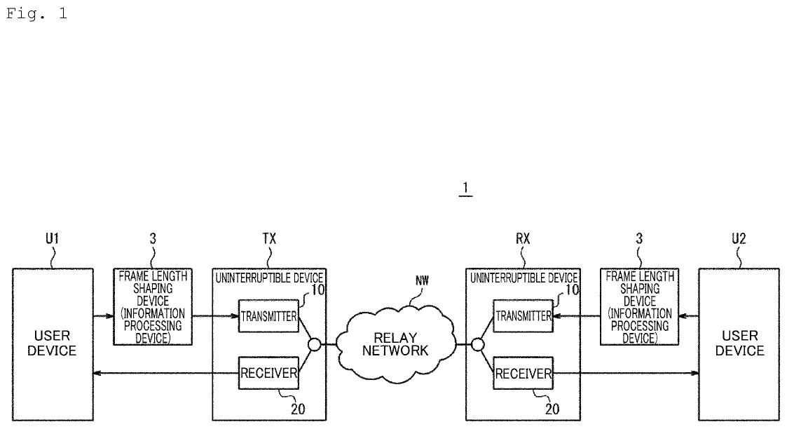

An overall configuration of the present embodiment will be described with reference to FIG. 1. FIG. 1 is a diagram showing an example of a communication system 1 according to the present embodiment.

### Communication System

The communication system 1 includes a user device U1, a user device U2, two frame length shaping devices 3 (information processing devices), an uninterruptible device TX (first communication device), and an uninterruptible device RX (second communication device). The user device U1 and the user device U2 are respectively connected to receivers of the uninterruptible device TX and the uninterruptible device RX. The user device U1 and the user device U2 are respectively connected to transmitters of the uninterruptible device TX and the uninterruptible device RX via the two frame length shaping devices 3. The two frame length shaping devices 3 may be integrated with the transmitters 10 of the uninterruptible devices TX and RX, which will be described in detail later. Further, the first communication device and the second communication device may be simply referred to as communication devices.

The user device U1 and the user device U2 may be directly connected to the uninterruptible device TX and the uninterruptible device RX, or may be indirectly connected via another communication device or a network. A relay network NW may be a wired network or a wireless network as long as a data unit can be transmitted through the relay network NW. Further, a communication protocol used in the relay network NW may be arbitrary.

A “data unit” may be a set of data, for example, a packet or a frame, or information similar to a packet or a frame. In addition, although the description will be made hereinafter by using a frame which is an example of a data unit, the present invention is not limited to the frame, and the data unit may be a packet or information similar to a packet or a frame. Therefore, a “frame length shaping device,” a “frame length comparison unit,” a “frame string,” a “frame length,” an “input frame,” and an “encoded frame” described below can be read as a “data unit length shaping device,” a “data unit length comparison unit,” a “data unit string,” a “data unit length,” an “input data unit,” and an “encoded data unit.”

### User Device

Each of the user device U1 and the user device U2 is configured as a computer including a memory, a controller, and a communication interface. The memory may be configured as a hard disk drive (HDD), a solid state drive (SSD), an electrically erasable programmable read-only memory (EEPROM), a read-only memory (ROM), a random access memory (RAM), or the like. The controller may be configured as dedicated hardware such as an application specific integrated circuit (ASIC) or a field-programmable gate array (FPGA), may be configured as a processor, or may include both. For the communication interface, for example, standards such as Ethernet (registered trademark), Fiber Distributed Data Interface (FDDI), and Wi-Fi (registered trademark) may be used.

The user device U1 and the user device U2 transmit a plurality of frames to the frame length shaping devices 3. The user device U1 and the user device U2 receive a plurality of frames from the frame length shaping devices 3.

### Frame Length Shaping Device

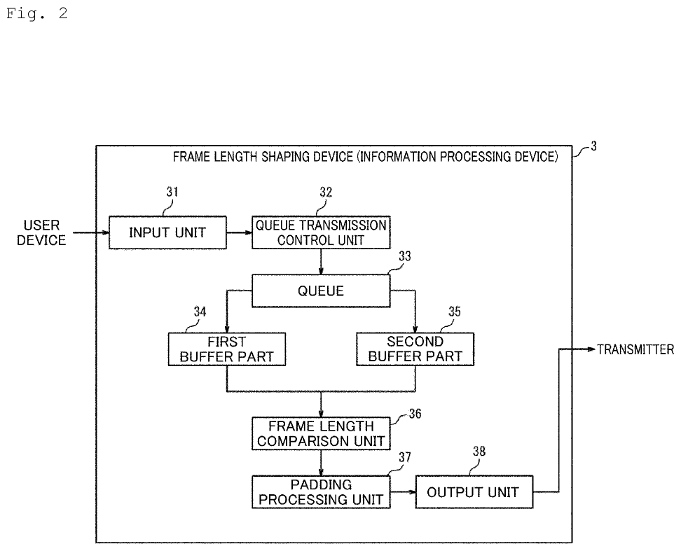

Next, the frame length shaping device 3 will be described with reference to FIG. 2. Here, the frame length shaping device 3 which receives the input of a frame output from the user device U1 among the two frame length shaping devices 3 shown in FIG. 1 will be described. Although description of the frame length shaping device 3 for receiving the input of a frame output from the user device U2 is omitted, the same applies except that processing is executed using the frame output from the user device U2.

As shown in FIG. 2, the frame length shaping device 3 includes an input unit 31, a queue transmission control unit 32, a queue 33, a first buffer part 34, a second buffer part 35, a frame length comparison unit 36, a padding processing unit 37, and an output unit 38. The input unit 31 is configured using an input interface. The input interface may be a communication interface. The queue transmission control unit 32, the frame length comparison unit 36, and the padding processing unit 37 are configured using a controller. The queue 33, the first buffer part 34, and the second buffer part 35 are composed of memories. The memories constituting the first buffer part 34, the second buffer part 35, and the queue 33 may be referred to as a first memory, a second memory, and a third memory. The output unit 38 is configured using an output interface. The input interface and the output interface may be a communication interface.

The input unit 31 receives input of a plurality of frames output by the user device U1 in order.

The queue transmission control unit 32 determines whether or not the sum of the frame length of an input frame received by the input unit 31 and the frame length of a frame stored in the queue 33 is shorter than an upper limit value UL. The upper limit value UL is a value appropriately determined by a manager or the like of the frame length shaping device 3. As the upper limit value UL increases, the risk of discarding a frame in the case of instantaneous interruption of a communication network or the like can be reduced. Further, since the frequency of padding processing is reduced, the effect of reducing the amount of data as a whole is enhanced. However, it takes a time proportional to the upper limit value UL to generate and transmit an encoded frame, and delay fluctuation at the time of a failure such as instantaneous interruption increases. In other words, as the upper limit value UL decreases, the risk of discarding a frame in the case of instantaneous interruption of a communication network or the like is reduced, and the frequency of performing padding processing increases, and thus the effect of reducing the amount of data as a whole is decreased, but delay fluctuation at the time of a failure such as instantaneous interruption is reduced. Therefore, it is desirable that the upper limit value UL be determined in consideration of the risk of discarding a frame in instantaneous interruption of a communication network and/or the frequency of padding processing, and delay fluctuation allowable in the network.

When it is determined that the sum is shorter than the upper limit value UL, the queue transmission control unit 32 stores the input frame in the queue 33. The queue transmission control unit 32 determines whether or not a frame is stored in the first buffer part 34 when it is determined that the sum is equal to or greater than the upper limit value UL.

When it is determined that no frame is stored in the first buffer part 34, the queue transmission control unit 32 stores a frame string including one or more frames stored in the queue 33 in the first buffer part 34 as a first frame string. When it is determined that a frame is stored in the first buffer part 34, the queue transmission control unit 32 stores a frame string stored in the queue 33 in the second buffer part 35 as a second frame string.

The queue 33 stores frames received by the input unit 31 under the control of the queue transmission control unit 32.

The first buffer part 34 stores the first frame string. Specifically, when it is determined that no frame is stored in the first buffer part 34, the first buffer part 34 stores frames stored in the queue 33 as the first frame string under the control of the queue transmission control unit 32. When the output unit 38 which will be described in detail later outputs a first frame to the uninterruptible device TX, the first frame is deleted from the first buffer part 34, and thus the first buffer part 34 is in a state in which no frame is stored therein.

The second buffer part 35 stores the second frame string. Specifically, when it is determined that a frame is stored in the first buffer part 34, the second buffer part 35 stores a frame stored in the queue 33 under the control of the queue transmission control unit 32. When the output unit 38 which will be described in detail later outputs a second frame to the uninterruptible device TX, the second frame is deleted from the second buffer part 35, and thus the second buffer parts is in a state in which no frame is stored therein.

The frame length comparison unit 36 compares the length of the first frame string composed of one or more frames consecutively received among a plurality of frames with the length of the second frame string composed of one or more frames consecutively received immediately after the frames constituting the first frame string. Specifically, when the first frame string is stored in the first buffer part 34 and the second frame string is stored in the second buffer part 35, the frame length comparison unit 36 determines which of the length of the first frame string and the length of the second frame string is shorter.

The padding processing unit 37 performs padding processing on either of the first frame string and the second frame string such that the first frame string and the second frame string have the same length. Specifically, the padding processing unit 37 performs padding processing on one frame string such that the length of one frame string, between the first frame string and the second frame string, determined to be shorter by the frame length comparison unit 36 becomes equal to the length of the other frame string.

More specifically, when the frame length comparison unit 36 determines that the length of the first frame string is shorter than the length of the second frame string, the padding processing unit 37 performs padding processing on the first frame string such that the length of the first frame string becomes equal to the length of the second frame string. Further, when the frame length comparison unit 36 determines that the length of the second frame string is shorter than the length of the first frame string, the padding processing unit 37 performs padding processing on the second frame string such that the length of the second frame string becomes equal to the length of the first frame string. When the frame length comparison unit 36 determines that the length of the first frame string is the same as the length of the second frame string, the padding processing unit 37 does not perform padding processing on any frame.

When padding processing is performed by the padding processing unit 37, the output unit 38 sequentially outputs the first frame string and the second frame string to the uninterruptible device TX. When the frame length comparison unit 36 determines that the length of the first frame string is the same as the length of the second frame string, the output unit 38 sequentially outputs the first frame string and the second frame string which are not subjected to padding processing to the uninterruptible device TX.

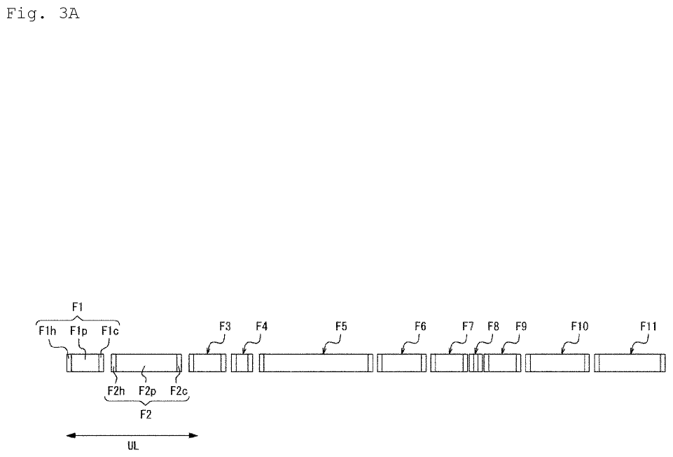

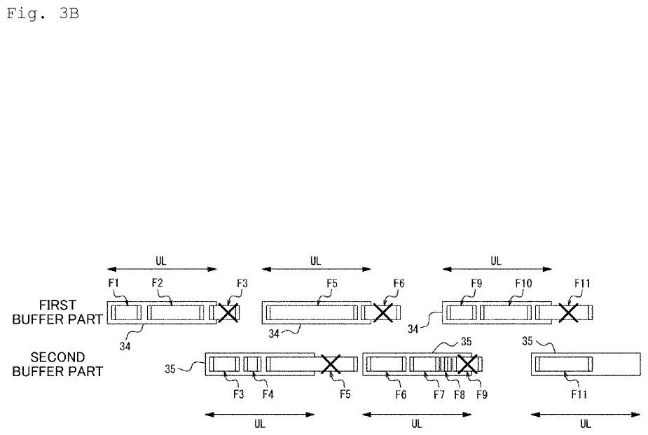

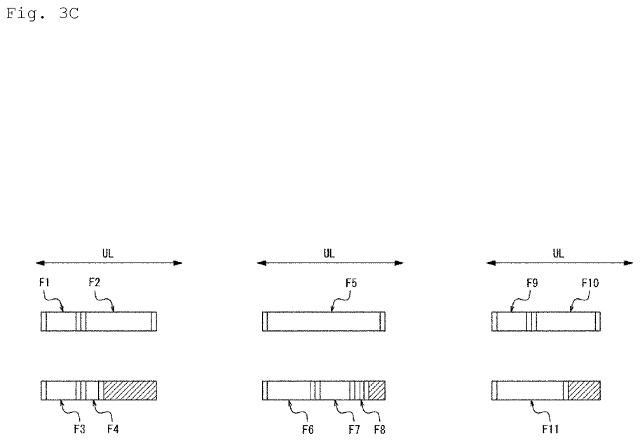

Here, a specific example of processing executed by each functional unit of the frame length shaping device 3 will be described with reference to FIGS. 3A, 3B, and 3C. In this example, no frame is stored in the first buffer part 34 and the second buffer part 35 in an initial state.

FIG. 3A shows a plurality of frames Fk (k is an integer of 1 to 11) having different frame lengths. In this example, frames received by the input unit 31 are sequentially marked with signs Fk including an integer k in ascending order. A frame F1 includes a header F1h, a payload F1p, and a frame check sequence F1c. Further, a frame F2 includes a header F2h, a payload F2p, and a frame check sequence F2c. Although a part is omitted in FIG. 3A, a frame Fk includes a header Fkh, a payload Fkp, and a frame check sequence Fkc in this manner.

In this example, when the input of the frame F1 shown in FIG. 3A is received by the input unit 31, the queue transmission control unit 32 determines whether or not the frame length of the frame F1 that is the input frame is shorter than the upper limit value UL. As shown in FIG. 3B, since the frame length of the frame F1 is shorter than the upper limit value UL, the queue transmission control unit 32 stores the frame F1 in the queue 33.

Next, when the input of the frame F2 shown in FIG. 3A is received by the input unit 31, the queue transmission control unit 32 determines whether or not the sum of the frame length of the frame F2 that is the input frame and the frame length of the frame F1 stored in the queue 33 is shorter than the upper limit value UL. As shown in FIG. 3B, since the sum of the frame length of the frame F2 and the frame length of the frame F1 is shorter than the upper limit value UL, the queue transmission control unit 32 further stores the frame F2 in the queue 33.

Next, when the input of a frame F3 shown in FIG. 3A is received by the input unit 31, the queue transmission control unit 32 determines whether or not the sum of the frame length of the frame F3 that is the input frame and the frame length of the frame F1 and the frame length of the frame F2 stored in the queue 33 is shorter than the upper limit value UL. As shown in FIG. 3B, since the sum is equal to or greater than the upper limit value UL, the queue transmission control unit 32 determines whether or not a frame is stored in the first buffer part 34. As described above, since no frame is stored in the first buffer part 34 at this time, the queue transmission control unit 32 stores the frame F1 and the frame F2 stored in the queue 33 in the first buffer part 34 and stores the frame F3 that is the input frame in the queue 33.

Next, when the input of a frame F4 shown in FIG. 3A is received by the input unit 31, the queue transmission control unit 32 determines whether or not the sum of the frame length of the frame F4 that is the input frame and the frame length of the frame F3 stored in the queue 33 is shorter than the upper limit value UL. As shown in FIG. 3B, since the sum is shorter than the upper limit value UL, the queue transmission control unit 32 further stores the frame F4 in the queue 33.

Next, when the input of a frame F5 shown in FIG. 3A is received by the input unit 31, the queue transmission control unit 32 determines whether or not the sum of the frame length of the frame F5 that is the input frame and the frame length of the frame F3 and the frame length of the frame F4 stored in the queue 33 is shorter than the upper limit value UL. As shown in FIG. 3B, since the sum is equal to or greater than the upper limit value UL, the queue transmission control unit 32 determines whether or not a frame is stored in the first buffer part 34. As described above, since the frames F1 and F2 are stored in the first buffer part 34 at this time, the queue transmission control unit 32 stores the frames F3 and F4 stored in the queue 33 in the second buffer part 35.

Subsequently, the frame length comparison unit 36 compares the length of the first frame string with the length of the second frame string to determine which frame length is shorter. In this example, the length of the first frame string is the length of the sum of the frames F1 and F2 stored in the first buffer part 34. The length of the second frame string is the length of the sum of the frames F3 and F4 stored in the second buffer part 35. In this example, as shown in FIG. 3C, the frame length comparison unit 36 determines that the length of the second frame string is shorter than the length of the first frame string. Then, the padding processing unit 37 performs padding processing on the second frame string such that the length of the second frame string becomes equal to the length of the first frame string. In FIG. 3C, portions on which padding has been performed are hatched.

Then, the output unit 38 sequentially outputs the first frame string and the second frame string to the transmitter 10 of the uninterruptible device TX. Then, the frames are deleted from the first buffer part 34 and the second buffer part 35, and no frame is stored in the first buffer part 34 and the second buffer part 35.

Subsequently, the input unit 31 receives the input of a frame F6 shown in FIG. 3A, and the same processing is repeated thereafter.

### Uninterruptible Device

Each of the uninterruptible device TX and the uninterruptible device RX includes the transmitter 10 and the receiver 20. The uninterruptible device TX and the uninterruptible device RX may be configured, for example, using a gateway, a router, or the like. The transmitter 10 and the receiver 20 of the uninterruptible device TX will be described hereinafter, but the same applies to the uninterruptible device RX.

### (Transmitter)

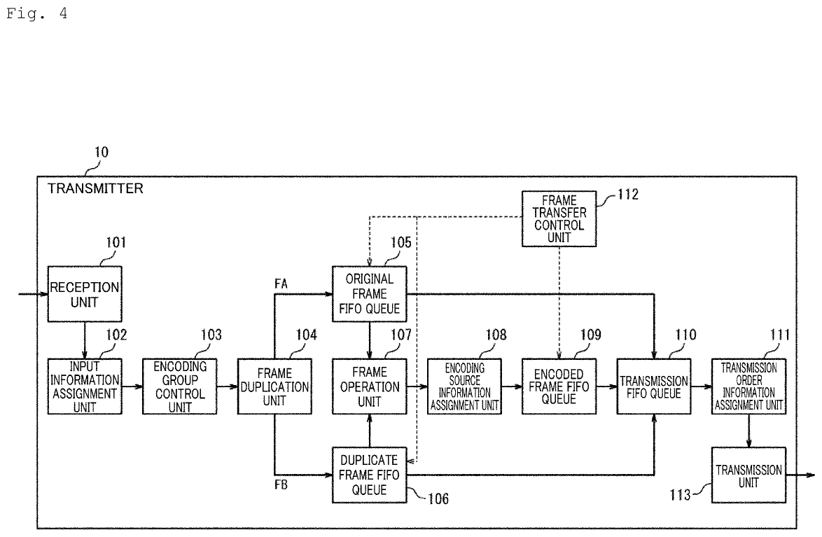

As shown in FIG. 4, the transmitter 10 includes a reception unit 101, an input order information assignment unit 102, an encoding group control unit 103, a frame duplication unit 104, an original frame First In First Out (FIFO) queue 105, a duplicate frame FIFO queue 106, a frame operation unit 107, an encoding source information assignment unit 108, an encoded frame FIFO queue 109, a transmission FIFO queue 110, a transmission order information assignment unit 111, a frame transfer control unit 112, and a transmission unit 113.

The reception unit 101 and the transmission unit 113 are configured using a communication interface. The input order information assignment unit 102, the encoding group control unit 103, the frame duplication unit 104, the frame operation unit 107, the encoding source information assignment unit 108, the transmission order information assignment unit 111, and the frame transfer control unit 112 are configured using a controller. The original frame FIFO queue 105, the duplicate frame FIFO queue 106, the encoded frame FIFO queue 109, and the transmission FIFO queue 110 are composed of memories.

The reception unit 101 receives frames (frames included in the first frame string and the second frame string) output by the frame length shaping device 3.

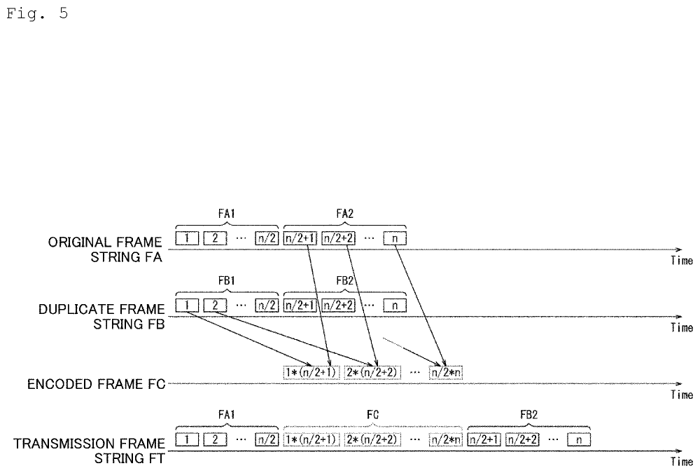

The input order information assignment unit 102 assigns a number to each frame in the input order for a frame string FA (a frame string FA1 and a frame string FA2 in FIG. 5) output by the frame length shaping device 3 and received by the reception unit 101. Here, the number assigned by the input order information assignment unit 102 is referred to as input order information. The input order information is assigned to a header or a payload of a frame, for example.

As shown in FIG. 5, the encoding group control unit 103 groups frames included in the frame string FA to which the input order information has been assigned for a plurality of preset frames n (n≥2). In the present embodiment, the encoding group control unit 103 groups one or more frames included in the first frame string (corresponding to the frame string FA1 in FIG. 5) stored in the first buffer part 34 and one or more frames included in the second frame string (corresponding to the frame string FA2 in FIG. 5) stored in the second buffer part 35 output from the aforementioned frame length shaping device 3.

The frame duplication unit 104 generates n duplicate frames corresponding to n frames constituting a group for each frame group grouped by the encoding group control unit 103. In the present embodiment, frames included in the frame string FA (original frame string FA) are original frames serving as a duplication source, and a frame string FB (duplicate frame string FB) is composed of duplicate frames obtained by duplicating the original frames. In the example shown in FIG. 5, a duplicate frame string FB1 and a duplicate frame string FB2 are generated by duplicating the frame string FA1 and the frame string FA2.

The original frame FIFO queue 105 stores n original frames included in the frame string FA1 and the frame string FA2 output from the frame duplication unit 104 in the input order and reads them in the input order.

The duplicate frame FIFO queue 106 stores n duplicate frames included in the duplicate frame string FB1 and the duplicate frame string FB2 output from the frame duplication unit 104 in the input order and reads them in the input order.

The frame operation unit 107 combines the original frame string FA2 stored in the original frame FIFO queue 105 and the duplicate frame string FB1 stored in the duplicate frame FIFO queue 106, and performs a predetermined encoding operation (exclusive OR) to generate an encoded frame FC having the same frame length as the original frame string FA2 and the duplicate frame string FB1. In this manner, the encoded frame FC is configured by an exclusive OR of one (the original frame string FA2 in the example of FIG. 5) of two frame strings sequentially received by the reception unit 101 and a duplicate frame string (the duplicate frame string FB1 in the example of FIG. 5) that is the other frame string. For this reason, the two frame strings need to have the same frame length in view of the nature of the operation. In the present embodiment, even if a frame output from the user device U1 has a variable length, two frame strings have the same length according to the frame length shaping device 3 as described above, and thus this processing can be performed. In the example shown in FIG. 5, the encoded frame FC including frames indicated by “1*(n/2+1),” “2*(n/2+2),” . . . , “n/2*n” is generated on the basis of frames indicated by “1,” “2,” . . . , “n/2” in the original frame string FA1 and frames indicated by “n/2+1,” “n/2+2,” . . . , “n” in the duplicate frame string FB1.

The encoding source information assignment unit 108 assigns input order information of the original frame string FA2 and input order information of the duplicate frame string FB1 used for an encoding operation to the encoded frame FC generated by the frame operation unit 107. The input order information of the original frame string FA2 and the duplicate frame string FB1 is called encoding source information.

The encoded frame FIFO queue 109 stores the encoded frame FC output from the encoding source information assignment unit 108 in the input order according to the encoding source information and reads the encoded frame FC in the input order.

The transmission FIFO queue 110 receives and stores the original frame string FA1, the duplicate frame string FB2, and the encoded frame FC read from the original frame FIFO queue 105, the duplicate frame FIFO queue 106, and the encoded frame FIFO queue 109 in the read order and reads them in the input order.

The transmission order information assignment unit 111 assigns a number indicating a transmission order to each header of the original frame string FA1, the duplicate frame string FB2, and the encoded frame FC read from the transmission FIFO queue 110. A number indicating a transmission order is referred to as transmission order information. The transmission order information assignment unit 111 outputs a transmission frame string FT including the original frame string FA1, the duplicate frame string FB2, and the encoded frame FC to which the transmission order information has been assigned to the transmission unit 113.

The frame transfer control unit 112 reads the original frame string FA2 and the duplicate frame string FB1 from the original frame FIFO queue 105 and the duplicate frame FIFO queue 106. Accordingly, the frame operation unit 107 can create the encoded frame FC using the read original frame string FA2 and duplicate frame string FB1. Further, the frame transfer control unit 112 reads the original frame string FA1 and the duplicate frame string FB2 from the original frame FIFO queue 105 and the duplicate frame FIFO queue 106, reads the encoded frame from the encoded frame FIFO queue 109, and stores them in the transmission FIFO queue.

The transmission unit 113 transmits the transmission frame string FT including the original frame string FA1, the duplicate frame string FB2, and the encoded frame FIFO queue 109 output from the transmission order information assignment unit 111 to the receiver 20 of the uninterruptible device RX via the relay network NW.

### (Receiver)

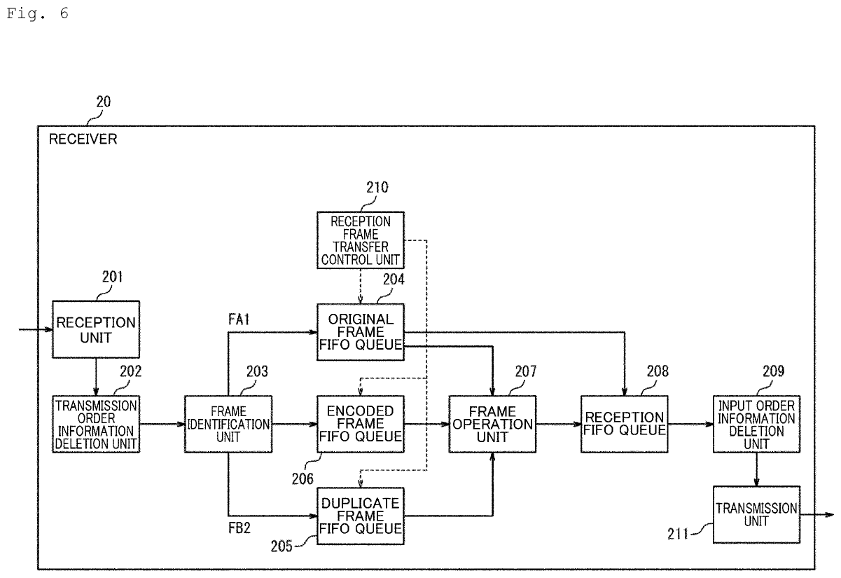

The receiver 20 included in the uninterruptible device TX will be described in detail with reference to FIG. 6. The receiver 20 includes a reception unit 201, a transmission order information deletion unit 202, a frame identification unit 203, an original frame FIFO queue 204, a duplicate frame FIFO queue 205, an encoded frame FIFO queue 206, a frame operation unit 207, a reception FIFO queue 208, an input order information deletion unit 209, a reception frame transfer control unit 210, and a transmission unit 211. The reception unit 201 and the transmission unit 211 are configured using a communication interface. In addition, the transmission order information deletion unit 202, the frame identification unit 203, the frame operation unit 207, the input order information deletion unit 209, and the reception frame transfer control unit 210 are configured using a controller.

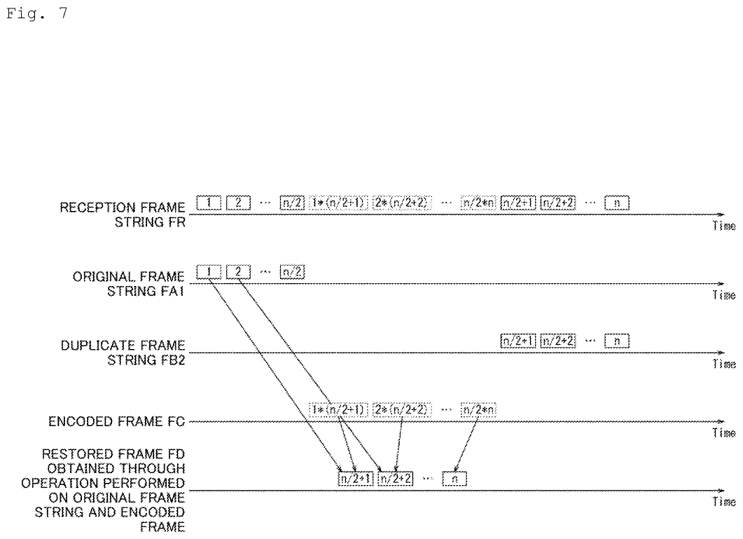

The reception unit 201 receives the transmission frame string FT transmitted from the transmitter 10 of the uninterruptible device RX as a reception frame string FR shown in FIG. 7.

The transmission order information deletion unit 202 deletes the transmission order information from the header of each of the original frame string FA1, the duplicate frame string FB2, and the encoded frame FC included in the reception frame string FR received by the reception unit 201 and inputs the frame string from which the transmission order information has been deleted to the frame identification unit 203.

The frame identification unit 203 identifies the input reception frame string FR as one of the original frame string FA1, the duplicate frame string FB2, and the encoded frame FC. Then, the frame identification unit 203 outputs the original frame string FA1 to the original frame FIFO queue 204, outputs the duplicate frame string FB2 to the duplicate frame FIFO queue 205, and outputs the encoded frame FC to the encoded frame FIFO queue 206.

The original frame FIFO queue 204 stores the original frames identified by the frame identification unit 203 in the input order and reads them in the input order. The duplicate frame FIFO queue 205 stores the duplicate frames identified by the frame identification unit 203 in the input order and reads them in the input order. The encoded frame FIFO queue 206 stores the encoded frames identified by the frame identification unit 203 in the input order and reads them in the input order.

The frame operation unit 207 may restore the duplicate frame string FB1 to be encoded in the transmitter 10 on the transmission side as a restoration frame string FD by performing a decoding operation using the encoded frame read from the encoded frame FIFO queue 206 and the original frame string FA1 read from the original frame FIFO queue 204. The frame operation unit 207 may restore the original frame string FA2 to be encoded in the transmitter 10 on the transmission side as a restoration frame string FD by performing a decoding operation on the basis of the encoded frame read from the encoded frame FIFO queue 206 and the duplicate frame string FB2 read from the duplicate frame FIFO queue 205.

The reception FIFO queue 208 stores the original frame string FA1 read from the original frame FIFO queue 204, the duplicate frame string FB2 read from the duplicate frame FIFO queue 205, and the restoration frame string FD restored by the frame operation unit 207 in the input order and reads them in the input order.

The input order information deletion unit 209 deletes the input order information from the header of each frame read from the reception FIFO queue 208.

The reception frame transfer control unit 210 reads the original frame string FA1 or the duplicate frame string FB2 from the original frame FIFO queue 203 or the duplicate frame FIFO queue 204 and reads the encoded frame FC from the encoded frame FIFO queue 205.

Specifically, when the duplicate frame string FB2 has been discarded due to instantaneous interruption of the relay network NW, or the like, the reception frame transfer control unit 210 reads the original frame string FA1 from the original frame FIFO queue 203 and reads the encoded frame FC from the encoded frame FIFO queue 205 as shown in FIG. 7. Accordingly, the frame operation unit 207 can restore the restoration frame string FD corresponding to the duplicate frame string FB2 using the read original frame string FA1 and encoded frame FC. In the example shown in FIG. 7, the restored frame FD including frames indicated by “n/2+1,” “n/2+2,” . . . , “n” corresponding to the duplicate frame string FB2 is generated on the basis of frames indicated by “1*(n/2+1),” “2*(n/2+2),” . . . , “n/2*n” included in the encoded frame FC and frames indicated by “1,” “2,” . . . , “n/2” in the original frame string FA1.

Further, when the original frame string FA1 has been discarded due to instantaneous interruption of the relay network NW, or the like, the reception frame transfer control unit 210 reads the duplicate frame string FB2 from the duplicate frame FIFO queue 204 and reads the encoded frame FC from the encoded frame FIFO queue 205. Accordingly, the frame operation unit 207 can restore the restoration frame string FD corresponding to the original frame string FA1 using the read duplicate frame string FB2 and the encoded frame FC.

When no instantaneous interruption occurs in the relay network NW and both the original frame string FA1 and the duplicate frame string FB2 are received, restoration processing may be omitted. In this manner, it is possible to reduce the processing load of the receiver 20 to decrease a transmission delay.

The transmission unit 211 transmits the frame string input to the reception FIFO queue 207 to the user device U1.

### Operation of Frame Length Shaping Device>

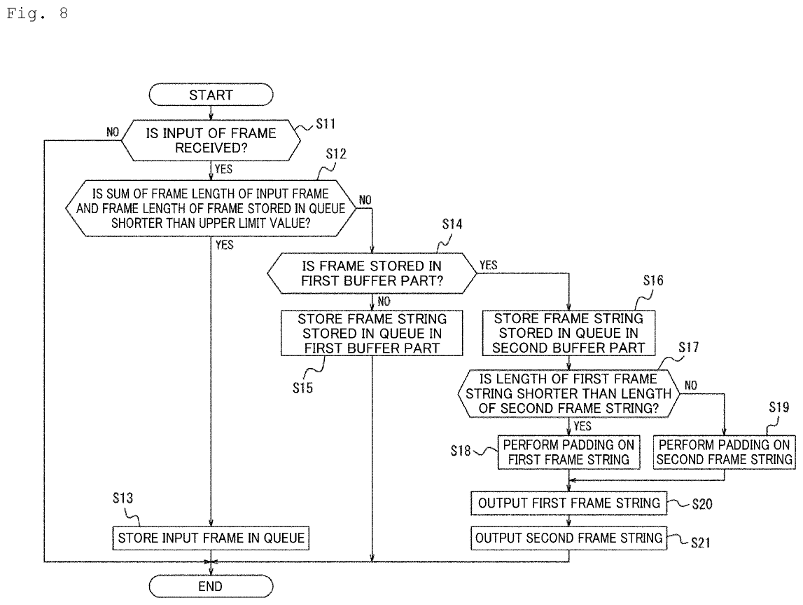

Here, an operation of the frame length shaping device 3 according to the present embodiment will be described with reference to FIG. 8. FIG. 8 is a flowchart showing an example of the operation of the frame length shaping device 3 according to the present embodiment. The operation in the frame length shaping device 3 described with reference to FIG. 8 corresponds to an example of a frame length shaping method (information processing method) of the frame length shaping device 3 according to the present embodiment. In this example, when a plurality of frames are output from the user device U1, the input unit 31 of the frame length shaping device 3 sequentially receives input of the plurality of frames. Then, the frame length shaping device 3 executes processing which will be described below every time input of a frame is received.

In step S11, the queue transmission control unit 32 determines whether or not the input unit 31 has received input of a frame.

In step S12, the queue transmission control unit 32 determines whether or not the sum of the frame length of the input frame which is the received frame and the frame length of a frame stored in the queue 33 is shorter than the upper limit value UL.

When it is determined that the sum is shorter than the upper limit value UL in step S12, the queue transmission control unit 32 stores the input frame in the queue 33 in step S13.

When it is determined that the sum is equal to or greater than the upper limit value UL in step S12, the queue transmission control unit 32 determines whether or not a frame is stored in the first buffer part 34 in step S14.

When it is determined that no frame is stored in the first buffer part 34 in step S14, the queue transmission control unit 32 stores a frame string including one or more frames stored in the queue 33 in the first buffer part 34 as a first frame string in step S15.

When it is determined that a frame string is stored in the first buffer part 34 in step S14, the queue transmission control unit 32 stores the frame string stored in the queue 33 in the second buffer part 35 as a second frame string in step S16.

In step S17, the frame length comparison unit 36 compares the length of the first frame string composed of one or more consecutively received frames among a plurality of frames with the length of the second frame string composed of one or more frames consecutively received immediately after the frames constituting the first frame string. Specifically, the frame length comparison unit 36 determines whether or not the length of the first frame string is shorter than the length of the second frame string.

In steps S18 and S19, the padding processing unit 37 performs padding processing on one frame string between the first frame string and the second frame string such that the length of one frame string determined to be short becomes the same as the length of the other frame string.

Specifically, when it is determined that the length of the first frame string is shorter than the length of the second frame string in step S17, the padding processing unit 37 performs padding processing on the first frame string in step S18. When it is determined that the length of the first frame string is longer than the length of the second frame string in step S17, the padding processing unit 37 performs padding processing on the second frame string in step S18. When it is determined that the length of the first frame string is the same as the length of the second frame string in step S17, the padding processing unit 37 does not perform padding processing on any frame string.

In step S20, the output unit 38 outputs the first frame string to the transmitter 10 of the uninterruptible device TX.

In step S21, the output unit 38 outputs the second frame string to the transmitter 10 of the uninterruptible device TX.

As described above, the frame length shaping device 3 as an information processing device according to the present embodiment includes the input unit 31 that sequentially receiving input of a plurality of frames, the frame length comparison unit 36 that compares the length of a first frame string composed of one or more consecutively received frames among a plurality of frames with the length of a second frame string composed of one or more frames consecutively received immediately after the frames constituting the first frame string, and the padding processing unit 37 that performs padding processing on either the first frame string or the second frame string such that the first frame string and the second frame string have the same length. Accordingly, the frame length shaping device 3 can prevent the length of the frame strings from increasing as compared with a case in which patting processing is performed such that both frame strings have a fixed length. Therefore, it is possible to curb reduction in frame string transfer efficiency while curbing loss of a frame string.

In addition, the frame length shaping device 3 as an information processing device according to the present embodiment further includes the queue 33 for storing a frame received by the input unit 31, and the queue transmission control unit 32 that determines whether or not the sum of the frame length of an input frame which is a received frame and the frame length of a frame stored in the queue 33 is shorter than the upper limit value UL, stores the input frame in the queue when it is determined that the sum is shorter than the upper limit value UL, determines whether or not a frame is stored in the first buffer part 34 when it is determined that the sum is equal to or greater than the upper limit value UL, stores a frame string including one or more frames stored in the queue 33 in the first buffer part 34 as a first frame string when it is determined that no frame is stored in the first buffer part 34, and stores a frame string stored in the queue 33 in the second buffer part 35 as a second frame string when it is determined that a frame string is stored in the first buffer part 34.

Accordingly, the frame length shaping device 3 performs padding processing on a frame string composed of one or more frames. Therefore, the frequency of padding processing may be reduced as compared with a case in which padding processing is performed on any one of frames by comparing the frames alone instead of a frame string. Therefore, the amount of data transmitted through the relay network NW may be further reduced as a whole.

### Program

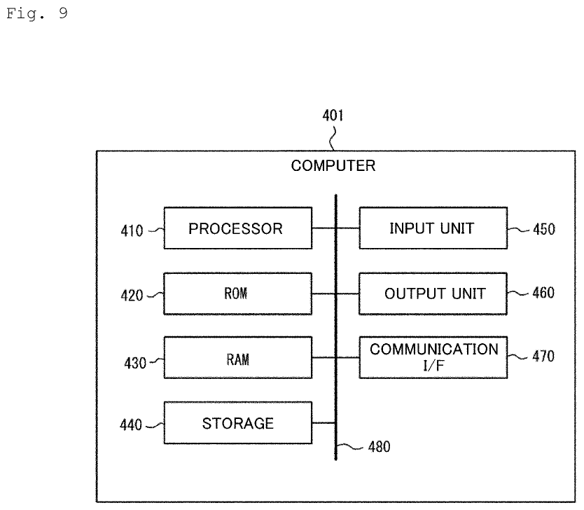

The above-described frame length shaping device 3 can be realized by a computer 401. Further, a program causing the computer 401 to function as the frame length shaping device 3 may be provided. Further, the program may be stored in a storage medium or may be provided via a network. FIG. 9 is a block diagram showing a schematic configuration of the computer 401 functioning as the frame length shaping device 3. Here, the computer 401 may be a general-purpose computer, a dedicated computer, a workstation, a personal computer (PC), an electronic notepad, or the like. Program instructions may be program code, code segments, or the like for executing necessary tasks.

As shown in FIG. 9, the computer 401 includes a processor 410, a read only memory (ROM) 420, a random access memory (RAM) 430, a storage 440, an input unit 450, an output unit 460, and a communication interface (I/F) 470. The components are connected such that they can communicate via a bus 480. The processor 410 is specifically a central processing unit (CPU), a micro processing unit (MPU), a graphics processing unit (GPU), a digital signal processor (DSP), a system on a chip (SoC), or the like and may include the same type or different types of multiple processors.

The processor 410 executes control of each component and various arithmetic operation processing. More specifically, the processor 410 reads a program from the ROM 420 or the storage 440 and executes the program using the RAM 430 as a work area. The processor 410 performs control of each component and various types of arithmetic operation processing in accordance with the program stored in the ROM 420 or the storage 440. In the above-described embodiment, the ROM 420 or the storage 440 stores the program according to the present disclosure.

The program may be recorded on a recording medium which can be read by the computer 401. A program can be installed in the computer 401 when such a recording medium is used. Here, the recording medium on which the program is recorded may be a non-transitory recording medium. The non-transitory recording medium is not particularly limited, but may be, for example, a CD-ROM, a DVD-ROM, a Universal Serial Bus (USB) memory, or the like. Further, this program may be downloaded from an external device over a network.

The ROM 420 stores various types of programs and various types of data. The RAM 430 serves as a work area and temporarily stores a program or data. The storage 440 is configured using a hard disk drive (HDD) or a solid state drive (SSD) and stores various programs including an operating system and various types of data.

The input unit 450 is an interface for receiving input of information, and the output unit 460 is an interface for outputting information.

The communication interface (I/F) 470 is an interface for communicating with an external device.

The following additional notes are disclosed in relation to the embodiments described above.

### [Additional Note 1]

An information processing device including:
an input interface for receiving input of a plurality of data units in order; and
a controller,
wherein the controller is configured to:
compare a length of a first data unit string composed of one or more consecutively received data units among the plurality of data units with a length of a second data unit string composed of one or more data units consecutively received immediately after the data units constituting the first data unit string; and
perform padding processing on one of the first data unit string and the second data unit string such that the lengths of the first data unit string and the second data unit string become equal to each other.

### [Additional Note 2]

The information processing device according to additional note 1, further including:
a first memory in which the first data unit string is stored; and
a second memory in which the second data unit string is stored,
wherein the controller is configured to determine which of the length of the first data unit string and the length of the second data unit string is shorter when the first data unit string is stored in the memory and the second data unit is stored in the memory.

### [Additional Note 3]

The information processing device according to additional note 2, further including a third memory in which the data unit received by the input interface,
wherein the controller is configured: to determine whether or not a sum of a data unit length of an input data unit that is the received data unit and a data unit length of a data unit stored in the third memory is shorter than an upper limit value; to store the input data unit in the third memory when it is determined that the sum is shorter than the upper limit value, to determine whether or not a data unit is stored in the first memory when it is determined that the sum is equal to or greater than the upper limit value, to store a data unit string including one or more data units stored in the third memory in the first memory as a first data unit string when it is determined that no data unit is stored in the first memory, and to store a data unit string stored in the third memory in the second memory as a second data unit string when it is determined that a data unit string is stored in the first memory.

### [Additional Note 4]

The information processing device according any one of additional notes 1 to 3, wherein the controller performs padding processing on one of the first data unit string and the second data unit string such that the length of one data unit string determined to be shorter becomes equal to the length of the other data unit string.

### [Additional Note 5]

An information processing method including:
receiving input of a plurality of data units in order;
comparing a length of a first data unit string composed of one or more consecutively received data units among the plurality of data units with a length of a second data unit string composed of one or more data units consecutively received immediately after the data units constituting the first data unit string; and
performing padding processing on one of the first data unit string and the second data unit string such that the lengths of the first data unit string and the second data unit string become equal to each other.

### [Additional Note 6]

A communication system including an information processing device and a communication device,
wherein the information processing device includes:
An information processing device including:
an input interface for receiving input of a plurality of data units in order; and
a controller,
wherein the controller is configured to:
compare a length of a first data unit string composed of one or more consecutively received data units among the plurality of data units with a length of a second data unit string composed of one or more data units consecutively received immediately after the data units constituting the first data unit string; and
perform padding processing on one of the first data unit string and the second data unit string such that the lengths of the first data unit string and the second data unit string becomes equal to each other, and
the communication device generates an encoded data unit on the basis of the first data unit string and the second data unit string having the same length according to the padding processing performed by the information processing device.

### [Additional Note 7]

A non-transitory storage medium storing a program executable by a computer, the program causing the computer to function as the information processing device according to any one of additional notes 1 to 3.

All literature, patent applications, and technical standards described herein are incorporated herein by reference to the same extent as when each individual publication, patent application and technical standard are specifically and individually described as being incorporated by reference.

Although the above-described embodiment has been introduced as a typical example, it is clear for a person skilled in the art that many alterations and substitutions are possible within the gist and scope of the present disclosure. Therefore, the embodiment described above should not be interpreted as limiting, and the present invention can be modified and altered in various ways without departing from the scope of the claims.

### REFERENCE SIGNS LIST

1 Communication system
3 Frame length shaping device (information processing device)
10 Transmitter
20 Receiver
31 Input unit
32 Queue transmission control unit
33 Queue (third memory)
34 First buffer part (first memory)
35 Second buffer part (second memory)
36 Frame length comparison unit
37 Padding processing unit
38 Output unit
101 Reception unit
102 Input order information assignment unit
103 Encoding group control unit
104 Frame duplication unit
105 Original frame FIFO queue
106 Duplicate frame FIFO queue
107 Frame operation unit
108 Encoding source information assignment unit
109 Encoded frame FIFO queue
110 Transmission FIFO queue
111 Transmission order information assignment unit
112 Transmission frame transfer control unit
113 Transmission unit
201 Reception unit
202 Transmission order information deletion unit
203 Frame identification unit
204 Original frame FIFO queue
205 Duplicate frame FIFO queue
206 Encoded frame FIFO queue
207 Frame operation unit
208 Reception FIFO queue
209 Input order information deletion unit
210 Reception frame transfer control unit
211 Transmission unit
401 Computer
410 Processor
420 ROM
430 RAM
440 Storage
450 Input unit
460 Output unit
470 Communication I/F
480 Bus
U1, U2 User device
TX uninterruptible device (first communication device)
RX uninterruptible device (second communication device)

1. An information processing device comprising a processor configured to execute operations comprising:
receiving input of a plurality of data units in order;
comparing a length of a first data unit string composed of one or more consecutively received data units among the plurality of data units with a length of a second data unit string composed of one or more data units consecutively received immediately after the data units constituting the first data unit string; and
performing padding processing on one of the first data unit string and the second data unit string such that the lengths of the first data unit string and the second data unit string become equal to each other.

2. The information processing device according to claim 1, comprising:
storing the first data unit string in a first buffer part;
storing the second data unit string in a second buffer part,
wherein the comparing further comprises determining which of the length of the first data unit string and the length of the second data unit string is shorter when the first data unit string is stored in the first buffer part and the second data unit is stored in the second buffer part.

3. The information processing device according to claim 2, the processor further comprises operations comprising:
storing the data unit received by the input unit in a queue; and
determining whether or not a sum of a data unit length of an input data unit that is the received data unit and a data unit length of a data unit stored in the queue is shorter than an upper limit value;
storing the input data unit in the queue when it is determined that the sum is shorter than the upper limit value;
determining whether or not a data unit is stored in the first buffer part when it is determined that the sum is equal to or greater than the upper limit value;
storing a data unit string including one or more data units stored in the queue in the first buffer part as a first data unit string when it is determined that no data unit is stored in the first buffer part; and
storing a data unit string stored in the queue in the second buffer part as a second data unit string when it is determined that a data unit string is stored in the first buffer part.

4. Currently Amended) The information processing device according to claim 1. wherein the performing padding processing further comprises performing the padding processing on one of the first data unit string and the second data unit string such that the length of one data unit string determined to be shorter becomes equal to the length of the other data unit string.

5. A method for processing information, comprising:
receiving input of a plurality of data units in order;
comparing a length of a first data unit string composed of one or more consecutively received data units among the plurality of data units with a length of a second data unit string composed of one or more data units consecutively received immediately after the data units constituting the first data unit string; and
performing padding processing on one of the first data unit string and the second data unit string such that the lengths of the first data unit string and the second data unit string become equal to each other.

6. A communication system comprising an information processing device and a communication device,
wherein the information processing device comprises a first processor configured to execute operations comprising:
receiving input of a plurality of data units in order;
comparing a length of a first data unit string composed of one or more consecutively received data units among the plurality of data units with a length of a second data unit string composed of one or more data units consecutively received immediately after the data units constituting the first data unit string; and
performing padding processing on one of the first data unit string and the second data unit string such that the lengths of the first data unit string and the second data unit string become equal to each other; and
the communication device comprises a second processor configured to execute operations comprising:
generating an encoded data unit on the basis of the first data unit string and the second data unit string having the same length according to the padding processing performed by the information processing device.

7. (canceled)

8. The information processing device according to claim 1, further comprising:
generating third data unit string, wherein the third data unit string as an encoded frame based on an exclusive OR value of the first data unit string and the second data unit string; and
transmitting the third data over a network.
